(19) United States
(12) Patent Application Publication
(10) Pub. No.: US 2011/0234628 A1
(43) Pub. Date: Sep. 29, 2011

(54) DISPLAY AND INFORMATION SHARING SYSTEM USING THE SAME

(75) Inventor: LUNG DAI, Tu-Cheng (TW)

(73) Assignee: HON HAI PRECISION INDUSTRY CO., LTD., Tu-Cheng (TW)

(21) Appl. No.: 12/848,880

(22) Filed: Aug. 2, 2010

(30) Foreign Application Priority Data
Mar. 29, 2010 (TW) 99109456

(51) Int. Cl. G09G 5/00

(52) U.S. Cl. 345/629; 345/1.1

(57) ABSTRACT

A display includes an interface and a display unit. The interface is adapted to electrically connect with a control device. The display unit is adapted to display first information when the control device outputs the first information to the interface. The display unit is capable of simultaneously displaying the first information and second information different from the first information when the control device only outputs the first information.

### BACKGROUND

1. Technical Field

The present disclosure relates to information sharing system; and particularly to an information sharing system using a number of displays.

2. Description of Related Art

Commonly, a computer and a number of displays connected to the computer combine to form an information sharing system. The computer can display the first information and control the displays to display the first information simultaneously to share among many viewers. However, when one of the viewers needs to understand the first information with the help of second information, the viewer must operate the computer to obtain the second information. However, all displays will display the second information, thus it may be inconvenient for other viewers who do not need the second information.

Therefore, there is room for improvement in the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout two views.

FIG. 1 is a schematic view of an information sharing system in accordance with an exemplary embodiment. The system includes a number of displays.

FIG. 2 is a block diagram of the display of FIG. 1 in accordance with an exemplary embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

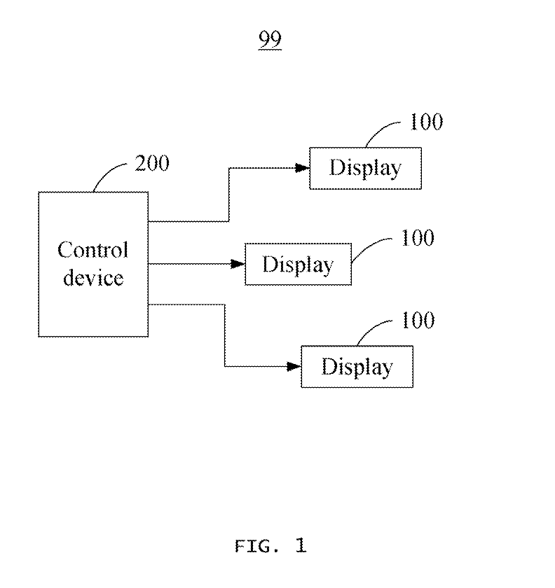

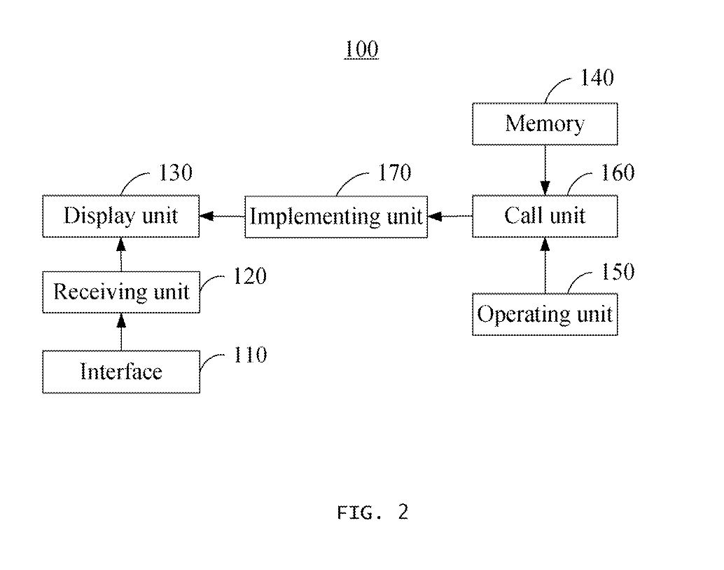

Referring to FIGS. 1 and 2, an information sharing system 99 includes a number of displays 100, and a control device 200 electrically connected to the displays 100. The displays 100 may be CRT displays, LCD displays or LED displays. The control device 200 may be a computer. The control device 200 is used for displaying first information and simultaneously transmitting the first information to the displays 100.

Each display 100 includes an interface 110, a receiving unit 120, a display unit 130, a memory 140, an operating unit 150, a call unit 160, and an implementing unit 170. The interface 110 is used for electrically connecting the control device 200 to the display 100. The interface 110 may be a VGA interface, a DVI interface, or a HDMI interface.

The receiving unit 120 is used for receiving the first information transmitted by the control device 200 to the interface 110, and transferring the first information to the display unit 130 such that the display unit 130 displays the first information.

The memory 140 is used for storing a number of applications. The applications include, but are not limited to, electronic map software, or electronic dictionary software.

The operating unit 150 is used for generating an operating signal in response to user's operations. The operating unit 150 includes a number of buttons arranged on the display 100, or a number of menu items displayed by the display 100. When the operating unit 150 includes a number of buttons, a one to one relationship exists between the buttons and the applications stored in the memory 140. When the operating unit 150 includes a number of menu items, a one to one relationship exists between the menu items and the applications stored in the memory 140.

The operating unit 150 may include buttons and menu items. In one embodiment, one button is arranged on the display 100, and the display 100 displays a number of menu items when the button is pressed. A one to one relationship exists between the menu items and the applications stored in the memory 140.

The call unit 160 is used for calling the corresponding application from the memory 140 in response to the operating signal.

The implementing unit 170 is used for implementing the called application, and displaying second information corresponding to the implemented application on the display unit 130. The second information is different from the first information. The second information is simultaneously displayed with the first information in the form of Picture-In-Picture (PIP) or Picture-Out-Picture (POP).

Using the information sharing system 99, the control device 200 can display the first information, and control all displays 100 simultaneously to display the first information. Therefore, many viewers can share the first information via the displays 100.

Furthermore, each display 100 can respond to the operating signal generated by the operating unit 150 to call the corresponding application from the memory 140 and implement the called application, and then display the second information corresponding to the implemented application. Therefore, when one of the viewers needs to understand the first information with the help of the second information, the viewer can obtain the second information, operating the one display 100 at a local station to call the application corresponding to the second information from the memory 140, and not by operating the control device 200, thus the first information and the second information are only displayed by the display 100 at the local station simultaneously, and it is very convenient.

In addition, when the display 100 used by the viewer simultaneously displays the first information and the second information, the control device 200 and the displays 100 used by other viewers only display the first information. Therefore, other viewers are not distracted by any needless second information.

It is to be understood, even though information and advantages of the present embodiments have been set forth in the foregoing description, together with details of the structures and functions of the present embodiments, the disclosure is illustrative only; and that changes may be made in detail, especially in matters of shape, size, and arrangement of parts within the principles of the present embodiments to the full extent indicated by the broad general meaning of the terms in which the appended claims are expressed.

What is claimed is:

1. A display, comprising:
an interface adapted to electrically connect with a control device; and
a display unit adapted to display first information when the control device outputs the first information to the interface;
wherein the display unit is capable of simultaneously displaying the first information and second information different from the first information when the control device only outputs the first information.

2. The display according to claim 1, wherein the first information and the second information are simultaneously displayed in the form of Picture-In-Picture.

3. The display according to claim 1, wherein the first information and the second information are simultaneously displayed in the form of Picture-Out-Picture.

4. The display according to claim 1, further comprising:
a receiving unit adapted to receive the first information transmitted by the control device to the interface, and transfer the first information to the display unit such that the display unit displays the first information;
a memory adapted to store a plurality of applications;
an operating unit adapted to generate an operating signal in response to user's operations;
a call unit adapted to respond to the operating signal to calling the corresponding application from the memory; and
an implement unit adapted to implement the called application, and display the second information corresponding to the called application on the display unit.

5. The display according to claim 4, wherein the operating unit comprises a plurality of buttons arranged on the display, and a one to one relationship exists between the buttons and the applications stored in the memory.

6. The display according to claim 4, wherein the operating unit comprises a plurality of menu items displayed by the display, and a one to one relationship exists between the menu items and the applications stored in the memory.

7. The display according to claim 4, wherein the operating unit comprises a button arranged on the display and a plurality of menu items displayed by the display, the display unit displays the plurality of menu items when the button is pressed, and a one to one relationship exists between the menu items and the applications stored in the memory.

8. The display according to claim 4, wherein the applications comprise electronic map software.

9. The display according to claim 4, wherein the applications comprise electronic dictionary software.

10. A display, comprising:
an interface adapted to electrically connect with a control device;
a display unit adapted to display first information under the control of the control device, and display second information different from the first information in response to user's operations thereon;
wherein the display is capable of displaying the first information and the second information simultaneously.

11. The display according to claim 10, wherein the first information and the second information are simultaneously displayed in the form of Picture-In-Picture.

12. The display according to claim 10, wherein the first information and the second information are simultaneously displayed in the form of Picture-Out-Picture.

13. The display according to claim 10, wherein when the display simultaneously displays the first information and the second information, the control device is capable of only displaying the first information.

14. A information sharing system, comprising:
a control device adapted to display first information; and
a plurality of displays connecting with the control device, the displays all displaying the first information when the control device outputs the first information to the displays, and capable of respectively displaying second information different from the first information in response to user's operations thereon;
wherein when one of the displays simultaneously displays the first information and second information, the control device only outputs the first information.

15. The information sharing system according to claim 14, wherein when the one of the displays simultaneously displays the first information and second information, the other displays is capable of only displaying the first information.

16. The information sharing system according to claim 14, wherein the first information and the second information are simultaneously displayed in the form of Picture-In-Picture.

17. The information sharing system according to claim 14, wherein the first information and the second information are simultaneously displayed in the form of Picture-Out-Picture.

18. The information sharing system according to claim 14, wherein each display comprises:
a receiving unit adapted to receive the first information transmitted by the control device to the interface, and transfer the first information to the display unit such that the display unit displays the first information;
a memory adapted to store a plurality of applications;
an operating unit adapted to generate an operating signal in response to user's operations;
a call unit adapted to respond to the operating signal to calling the corresponding application from the memory; and
an implement unit adapted to implement the called application, and display the second information corresponding to the called application on the display unit.
